(19) United States
(12) Patent Application Publication
(10) Pub. No.: US 2011/0253548 A1
(43) Pub. Date: Oct. 20, 2011

(54) ELECTROLYTE WITH LOWERED RIGIDITY, AND ELECTROCHEMICAL SYSTEM COMPRISING SUCH AN ELECTROLYTE

(75) Inventors: Stephane Di Iorio, Lans-En-Vercors (FR); Thibaud Delahaye, Tresques (FR)

(73) Assignee: Comm. A L'Energie Atomique et Aux Energies Alt., Paris (FR)

(21) Appl. No.: 13/126,862

(22) PCT Filed: Oct. 28, 2009
(86) PCT No.: PCT/EP2009/064194

§ 371 Date: Jun. 29, 2011

(30) Foreign Application Priority Data
Oct. 30, 2008 (FR) 0857407

(51) Int. Cl. C25B 9/18; H01M 8/24; B05D 3/02; C25B 13/02; C25B 9/00; B05D 3/06; H01M 8/12; H01M 8/00

(52) U.S. Cl. 205/334; 429/465; 204/252; 204/253; 427/554

(57) ABSTRACT

An electrolyte plate for an electrochemical system including a first and a second face opposite to each other of larger surface areas, both faces being separated by a given distance. The first face includes linear protrusions and the second face includes linear recesses, the protrusions and the recesses being substantially parallel to each other. Each protrusion is superposed to a recess along a direction substantially orthogonal to a mean plane of the plate, the distance separating a bottom of each recess from a vertex of the superposed protrusion being substantially equal to the distance between the first and the second face so that the electrolyte plate has a substantially constant thickness.

### TECHNICAL FIELD AND PRIOR ART

The present invention relates to an electrolyte with lowered rigidity for fuel cells and for electrolyzers, more particularly for high temperature fuel cells of the SOFC (Solid Oxide Fuel Cell) type and for high temperature electrolyzers (HTE).

An electrochemical system such as a fuel cell or an electrolyzer comprises a stack of cells, each cell comprising an anode, a cathode and a solid electrolyte interposed between the anode and the cathode. The electrolyte is in a ceramic material.

The lifetime of a high temperature cell or of a high temperature electrolyzer is notably conditioned by the mechanical strength of each cell, and more particularly by the mechanical strength of the electrolyte, in the case of cells with a supporting electrolyte.

Now, the cells are subject to mechanical loads, during manufacturing and during operation of the electrochemical system. In order to obtain a good electric contact between the different layers of the stack, a mechanical load is applied to the stack along its axis during the assembling of the electrochemical system. This mechanical load may be obtained by applying a predetermined displacement. The greater the rigidity of the cell, the more these displacements generate significant stresses. If these stresses are too high, they may cause failure of the cell. Moreover, high temperature operation strongly stresses the different layers. The damaging of the different layers may reduce the performances of the electrochemical system, or even completely prevent its operation.

In the case of an imposed displacement, a possible solution for reducing the risks of damages is to decrease the thickness of the layers forming the cells, notably that of the electrolyte, which has the effect of reducing the rigidity of the cell and therefore the stresses generated on the cell. However a decrease in thickness is difficult to achieve technically, and does not allow fine adaptation of the rigidity of the cell to the stresses which it undergoes.

Document U.S. Pat. No. 7,045,234 describes an electrolyte in ceramic, comprising bumps or spikes on its two faces intended to receive the electrodes. However these bumps or spikes have no effect on the rigidity of the electrolyte.

Therefore an object of the present invention is to provide a solid electrolyte providing lowered rigidity, without changing its thickness, or to more generally provide an electrochemical system with an increased lifetime.

### Discussion of the Invention

The object stated earlier is achieved by an electrolyte plate in a ceramic material for a fuel cell or electrolyzer, comprising on one of the two faces protruding strips in the form of lines and on the other face, recessed strips in the form of lines, these strips being for each face substantially parallel with each other. This structuration notably allows lowering of the rigidity of the electrolyte for an imposed displacement load, and therefore lowering of the rigidity of the cell as a whole. With this it is possible to reduce the stresses which the cell undergoes, and optionally to control their distribution. The lifetime of the electrochemical system consisting of such cells is then increased.

Advantageously, the axis of each protruding strip is contained in a plane containing the axis of a recessed strip, said plane being substantially orthogonal to a mean plane of the plate.

In other words, the plate comprises trenches on both of its faces, parallel with each other in each face. Advantageously, the trenches of one face, seen as a section, are positioned between two trenches of the other face, so that the thickness of the thereby structured plate remains substantially constant over the whole of its extent.

It is advantageous to provide protrusions having a height greater than 2.5 μm, and recesses of the same depth as the height of the protrusions.

The subject-matter of the present invention is then mainly an electrolyte plate for an electrochemical system comprising first and second faces opposite to each other of larger surface areas, both faces being separated by a given distance, the first face comprising linear protrusions and the second face comprising linear recesses, the protrusions and the recesses being substantially parallel to each other, each protrusion being superposed to a recess along a direction substantially orthogonal to a mean plane of the plate, the distance separating a bottom of each recess from a vertex of the superposed protrusion being substantially equal to the distance between the first and the second face so that the electrolyte plate has a substantially constant thickness.

In an exemplary embodiment, the height of the protrusions, the depth of the recesses and the distance between the first and the second face of the plate are equal.

The protrusions and the recesses advantageously have cross-sections of identical shapes, for example in the form of an isosceles trapezium, and having substantially equal dimensions.

For example, the electrolyte plate according to the present invention has a thickness comprised between 25 μm and 2 mm, advantageously equal to 200 μm, the recesses having a height comprised between 5 μm and 1.5 mm, advantageously equal to 200 μm, and the recesses having a depth comprised between 5 μm and 1.5 mm, advantageously equal to 200 μm.

The subject-matter of the present invention is also an electrochemical system comprising at least one cell comprising an electrolyte plate according to the present invention, a cathode on one face among the first and second faces, an anode on the other one of its faces.

The electrochemical system may comprise a plurality of cells according to the invention connected in series by interconnecting plates positioned between an anode of a cell and a cathode of an adjacent cell.

The electrochemical system may be a fuel cell, for example a high temperature fuel cell of the SOFC type, or an electrolyzer, for example a high temperature electrolyzer.

The subject-matter of the present invention is also a method for manufacturing a plate according to the present invention comprising:
the strip casting step,
the step for producing patterns on the first and second faces of the plate by means of a laser device in a plate,
the step for sintering the plate,
the step for making the electrodes,
the step for sintering the electrodes.

### SHORT DESCRIPTION OF THE DRAWINGS

The present invention will be better understood by means of the description which follows and the appended drawings wherein:

FIG. 1 is a perspective view of an exemplary embodiment of an electrolyte plate according to the present invention,

FIG. 2A is a sectional view along the plane A-A of the plate of FIG. 1,

FIG. 2B is a sectional view of an alternative embodiment of a plate according to the present invention,

FIGS. 3A and 3B respectively illustrate the distribution of the stresses on a plate without any relief and on a plate of FIG. 1,

FIG. 4 is a longitudinal sectional view of a cell comprising electrolyte plates of FIG. 1.

DETAILED DISCUSSION OF PARTICULAR EMBODIMENTS

The electrolyte plates which will be described have the shape of a rectangular parallelepiped, however it is well understood that plates having the shape of a disc or any other shape do not depart from the scope of the present invention.

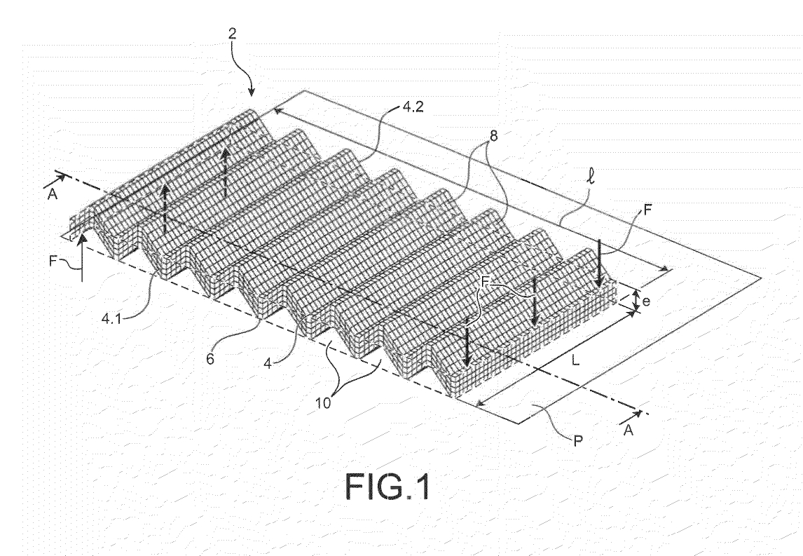

In FIG. 1, a first example of an electrolyte plate 2 according to the present invention with a mean plane P may be seen.

The plate 2 has the shape of a rectangular parallelepiped having a very small thickness e relatively to its width L and its length l. The plate is made in ceramic.

The plate has a first face 4 and a second face 6 of larger surface area, opposite to each other, with respect to the mean plane P. The first 4 and the second 6 face are separated by the distance e.

Both of these faces 4, 6 are intended to be facing each other, one for an anode and the other one for a cathode (illustrated in FIG. 8).

According to the present invention, the first face 4 comprises substantially linear protrusions 8 extending from a first edge 4.1 to a second edge 4.2 opposite to the first edge 4.1. In the illustrated example, the protrusions extend along the width of the plate. The second face 6 comprises recesses 10 or parallel linear ribs, also extending from the first edge 4.1 to the second edge 4.2.

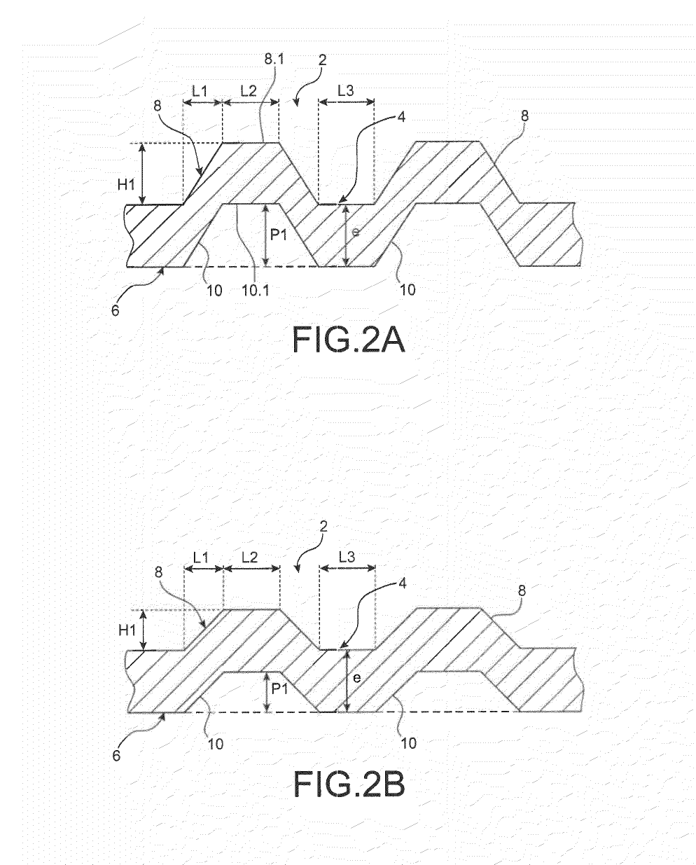

The terms of <<protrusion >> and <<recess >> describe the structure by taking as a reference the plate of thickness e, e being illustrated on FIGS. 1, 2A and 2B. The plate of thickness e is illustrated in dotted lines in FIG. 2A. Indeed, the thickness e is one of the characteristics of the plate, the latter defining the electronic resistance of the plate and therefore the electrochemical performances of the cell.

According to the invention, each protrusion is superposed to a recess 10 along the vertical direction. Further, the height of the protrusion and the depth of the superposed recess are substantially equal. Therefore, a bottom 10.1 of the recess and a vertex 8.1 of the protrusion are at a distance of e from each other. The plate then has a substantially constant thickness.

In the present application, by substantially constant thickness is meant a thickness for which the thickness changes of the electrolyte plate do not exceed 10% of its average thickness and are preferentially less than 5%.

Further according to the present invention, the depth of the recesses and the height of the protrusions are less than or equal to the distance (e) between the first and the second face.

Thanks to the fact that the depth of the recesses and the height of the protrusions are less than or equal to the distance e between both faces of the plate, the angles formed between the protrusions and recesses and the faces are very open, the stress concentrations are therefore small, so that the lifetime of the electrolyte cannot be decreased.

In FIG. 2A, a sectional view may be seen along the plane A-A of the plate of FIG. 1. In the example, the protrusions 8 have a section in the form of an isosceles trapezium, but it is quite understood that a protrusion having any trapezoidal section or semicircular section does not depart from the scope of the present invention.

In this exemplary embodiment, the depth P1 of the recesses and the height H1 of the protrusions are equal to the thickness e of the plate. As this will be seen subsequently, this configuration has less rigidity as compared with a configuration where the depth and the height are less than the thickness e, as this the case in FIG. 2B.

In the illustrated example, the recesses also have a trapezoidal section.

More generally, the protrusions and the recesses have substantially the same dimensions so that the thickness of the whole plate is substantially constant. With this, it is possible to avoid a change in the electronic resistance within the plate. The presence of the recesses and of the protrusions then only has very little influence on the electrochemical performances of the plate.

The trapezoidal section of a protrusion has a height H1, a small base of length L2 a large base of L2+2L1.

The trapezoidal section of a recess has a depth P1 equal to H1, a small base of length L2 and a large base of L2+2L1.

Further, in the illustrated example, the protrusions are regularly distributed on the faces 4, and the recesses on the face 6. The distance separating two edges of two adjacent protrusions or two adjacent recesses is L3 and is constant over the whole plate.

The protrusions 8 or the recesses 10, and more generally the relief on both faces 4, 6 have the effect of significantly reducing the rigidity of the electrolyte plate without changing the thickness of the plate. Indeed, reduction of the rigidity of the plate by reducing its thickness is technically difficult to achieve. By means of the invention, such a reduction is obtained without having to lower this thickness.

By means of the invention, the electrolyte plate provides reduced rigidity while having a thickness which does not vary substantially.

Further, the reliefs may be made on a limited portion of the plate, in order to reduce the stresses present in the most sensitive areas.

In FIG. 2B, an alternative embodiment of the plate of FIG. 1 may be seen, in which the depth P1 of the recesses 10 is less than the thickness e of the plate 2.

As an illustration, in order to show the effectiveness of the present invention, we shall compare the rigidity of plates according to the present invention with that of a base plate with a parallelepipedal shape having two opposite planar faces.

The rigidity of a material is characterized by the linear relationship between the applied stress a and the elastic deformation resulting from this stress. Young's modulus E corresponds to the slope of this straight line.

The following results were obtained from numerical simulation of a 3-point flexure test on plates having different configurations. The displacement is applied on the face 8. The applied constraints are symbolized by the arrows F.

A base plate is considered, having a thickness e=0.2 mm, a width L=2 mm and a length l=4 mm. This plate has Young's modulus E=200 GPa.

TABLE I
Results of simulation on the plates of FIGS. 2A and 2B.

| | | | H1 or | E_{equi} | |
|---|---|---|---|---|---|
| L1 (mm) | L2 (mm) | L3 (mm) | P1 (mm) | (GPa) | Variation |
| 0.05 | 0.05 | 0.05 | 0.05 | 175 | −12.7% |
| 0.1 | 0.1 | 0.1 | 0.1 | 141 | −29.4% |
| 0.2 | 0.2 | 0.2 | 0.2 | 126 | −37.2% |
| 0.2 | 0.05 | 0.05 | 0.2 | 107 | −46.3% |

The simulations, the results of which are gathered in Table I above, were carried out on a plate for which the section is similar to the one of FIGS. 2A and 2B. More particularly, the first two lines correspond to the dimensions of plates similar to those of FIG. 2B, and the last two lines correspond to the dimensions of plates similar to those of FIG. 2A.

The last column groups the ratio between the rigidity of the structured plate (i.e. the equivalent Young's modulus) and the rigidity of the non-structured plate (for which Young's modulus=200 GPa).

It is seen that by means of the presence of the patterns according to the present invention, the rigidity decreases significantly.

More particularly, it is seen that the deeper the recesses and the higher the protrusions, the more the rigidity is reduced. This corresponds to a plate similar to FIG. 2A.

With the present invention it is therefore possible to produce more flexible plates while retaining constant thickness.

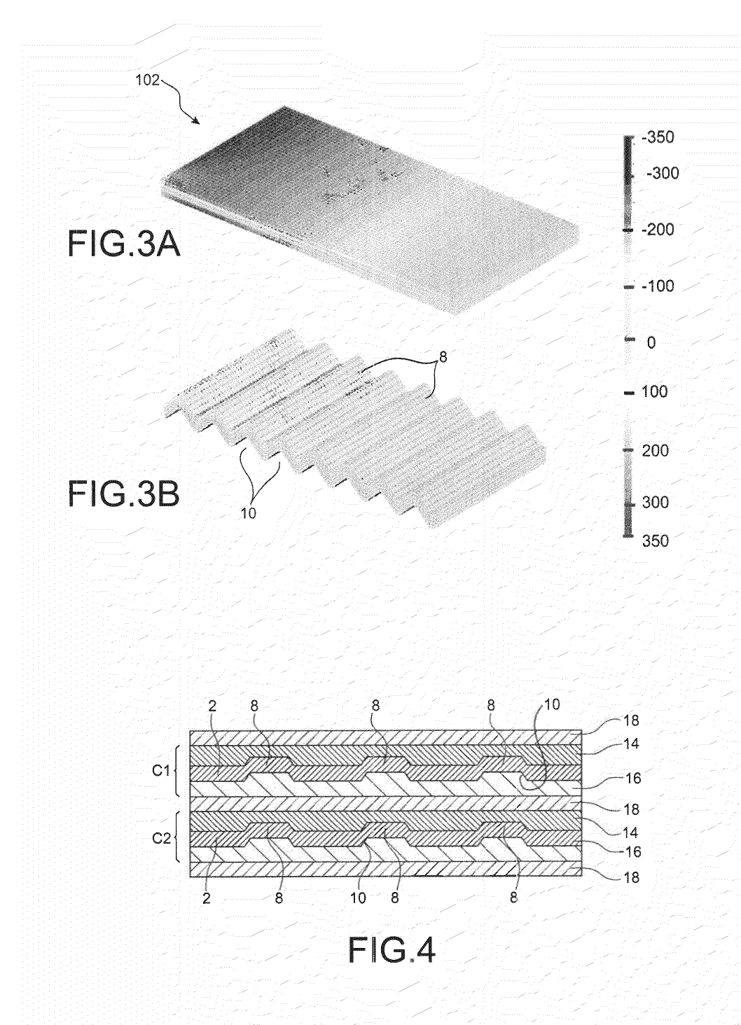

In FIGS. 3A and 3B, are illustrated the distributions of the stresses within a plate of the prior art 102 and within a plate 2 of FIG. 1 according to the invention, respectively.

It is seen that the maximum stress values are lowered by means of the present invention, and that their distribution within the plate is modified.

As an example, the following dimensions may be given:

The thickness e may be comprised between 25 μm and 2 mm, and may preferably be equal to 200 μm; the height H1 of the protrusions and the depth P1 of the recesses may be comprised between 5 μm and 1.5 mm, and may preferably be equal to 200 μm; the dimension L1 may be comprised between 10 μm and 1 mm, and may preferably be equal to 200 μm; the dimension L2 may be comprised between 10 μm and 1 mm, and may preferably be equal to 50 μm; the dimension L3 may be comprised between 10 μm and 1 mm, and may preferably be equal to 50 μm.

The ratio between L3 and L2+2L1 is for example comprised between 0.05 and 33.3, and preferably between 0.1 and 1.

As an example, the electrolyte may be in yttriated zirconia (YSZ), the oxygen electrode may be in lanthanum chromite doped with strontium (LSM), and the hydrogen electrode may be an yttriated zirconium/nickel (Ni-YSZ) cermet.

The material of the electrolyte plate may also be 8YSZ, 3YSZ, 10ScSZ, 10Sc1CeSZ, 10Sc1ASZ, 10Sc1YSZ, 5YbSZ, BCY, BCZY, BCG, BZY, BCZG.

The design of the shape of the plate notably of the arrangement, of the distribution and of the dimensions of the relief may be obtained by a finite element calculation.

The electrolyte plate may be made according to known techniques, for example by strip casting. The thickness of the plate before structuration takes into account the relief to be made. The structuration of the faces of the plate is made “in a coarse way”, for example by means of a laser device, the path of which may be programmed by means of a computer. The power of the beam should be selected so as to dig into the surface of the plate without breaking the cell. A first structuration is carried out on a first face, and then the electrolyte plate is turned over so as to allow structuration of the other face.

In this exemplary method embodiment, the making of the patterns is obtained by removing material. Trenches are engraved in each of the faces.

Very accurate positioning of the cell is sought in order to obtain good structuration.

The steps following the structuration step of the two faces are those of a conventional method for making a cell, notably the sintering step of the electrolyte plate, and then the step for making the electrodes, for example by screen printing, and then the step for sintering the electrodes.

The invention therefore does not involve any significant modification of the method for manufacturing the cells from the state of the art, since it only requires the addition of a single step: the structuration by a laser beam.

By means of the present invention, the mechanical performances of a cell are increased without reducing the electrochemical performances of the latter. Accordingly, the making of an industrial fuel cell is facilitated since the cell core is more performing. The lifetime of fuel cells is then increased since the mechanical load on the cell core is more adapted to what the cells may withstand.

In FIG. 4, an exemplary SOFC cell according to the present invention may be seen, comprising a stack of cells C1, C2 each comprising a structured electrolyte plate similar to the one of FIG. 1, an anode 14 and a cathode 16. The cells are connected in series with interconnecting plates 18.

An electrolyzer according to the present invention is of a similar design to that of the cell of FIG. 4.

It is quite understood that the protrusions or recesses within a same face may not have the same dimensions.

1-9. (canceled)

10: An electrolyte plate for an electrochemical system, comprising:
a first and a second face opposite to each other of larger surface areas, both faces being separated by a given distance,
the first face comprising linear protrusions and the second face comprising linear recesses, the protrusions and the recesses being parallel to each other,
each protrusion being superposed to a recess along a direction orthogonal to a mean plane of the plate, a distance separating a bottom of each recess from a vertex of the superposed protrusion being substantially equal to a distance between the first and the second face so that the electrolyte plate has substantially constant thickness,
wherein a depth of the recesses and a height of the protrusions are less than or equal to the distance between the first face and the second face.

11: The electrolyte plate according to claim 10, wherein the height of the protrusions, the depth of the recesses, and the distance between the first face and the second face of the plate are substantially equal.

12: The electrolyte plate according to claim 10, wherein the protrusions and the recesses have cross-sections with identical shapes, or in a form of an isosceles trapezium, and having substantially equal dimensions.

13: The electrolyte according to claim 10, having a thickness between 25 μm and 2 mm, or equal to 200 μm, and wherein the protrusions have a height between 5 μm and 1.5 mm, or equal to 200 μm, and the recesses have a depth between 5 μm and 1.5 mm, or equal to 200 μm.

14: An electrochemical system comprising:
at least one cell comprising an electrolyte plate according to claim 10;
a cathode on one among the first and second faces; and
an anode on the other one of its faces.

15: An electrochemical system comprising:
a plurality of cells according to claim 14, connected in series through interconnecting plates positioned between an anode of a cell and a cathode of an adjacent cell.

16: The electrochemical system according to claim 15, being a fuel cell, or a high temperature fuel cell, or a SOFC fuel cell.

17: The electrochemical system according to claim 16, being a high temperature fuel cell of SOFC type.

18: The electrochemical system according to claim 15, being an electrolyzer, or a high temperature electrolyzer.

19: The electrochemical system according to claim 18, being a high temperature electrolyzer.

20: The electrolyte plate according to claim 11, wherein the protrusions and the recesses have cross-sections with identical shapes in a form of an isosceles trapezium, and having substantially equal dimensions.

21: The electrolyte according to claim 10, having a thickness equal to 200 μm, and wherein the protrusions have a height equal to 200 μm, and the recesses have a depth equal to 200 μm.

22: A method for manufacturing a plate according to claim 10, comprising:
strip casting;
producing patterns on the first face and the second face of the plate, by a laser device in a plate;
sintering the plate;
making the electrodes; and
sintering the electrodes.
